(19) United States
(12) Patent Application Publication
(10) Pub. No.: US 2005/0012852 A1
(43) Pub. Date: Jan. 20, 2005

(54) Apparatus and method for digital camera and enclosure

(76) Inventors: Robert G. Gann, Bellvue, CO (US); Michael L. Rudd, Fort Collins, CO (US); Donald J. Stavely, Windsor, CO (US); Amy E. Battles, Windsor, CO (US); Sarah J. Barrios, Fort Collins, CO (US); Robert E. Sobol, Fort Collins, CA (US); Kenneth J. Hall, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,353

(22) Filed: Jul. 18, 2003

(51) Int. Cl. H04N 5/225

(52) U.S. Cl. 348/373

(57) ABSTRACT

The present invention provides a system and method for capturing images. Briefly described, one embodiment comprises a digital camera, the digital camera comprising at least a photosensor; and an enclosure configured to receive the digital camera, configured to have at least one feature controlling operation of the digital camera, and configured to capture an image using the photosensor of the digital camera.

### TECHNICAL FIELD

The present invention is generally related to digital image capture devices and, more particularly, is related to a system and method for a digital camera enclosure.

### BACKGROUND

Many small and inexpensive digital cameras are available on the market. Such compact digital cameras are configured for easy, simple operation so that the user may simply “point-and-shoot” at an object of interest, thereby conveniently capturing an image of the object of interest. Many of the technical aspects related to image capture are automatic. Examples include ambient light condition sensing, focusing, flash settings, exposure time settings and the like. Accordingly, such devices have a minimum number of operating features so that the user need not spend time or be concerned with specifying various camera settings before capturing a good quality image of the object of interest. Historically, such compact digital cameras were equipped with smaller size, lower resolution image sensors. Also, to reduce the price and size, such compact digital cameras may have limited memory capacity and limited battery life. Compact digital cameras may be desirable for beginning photographers, inexperienced photographers, children, or even experienced photographers who are not interested in specifying a plurality of complex camera settings for the image that they are capturing.

On the other hand, advanced photographers desire great control of the technical aspects related to image capture when the user is capturing certain types of images. For example, the user may be “photographing” portraits, wildlife, panoramic scenic views or news related images. Often, the user is a professional photographer. Thus, a complex digital camera provides the user a great deal of control over camera operation. Such control necessarily requires numerous interface devices, such as complex menus, a plurality of controllers such as buttons, switches and/or dials, and a lens coupling means so that a plurality of different, specialized lens may be attached to the advanced digital camera body. Complex digital cameras are often equipped with larger size, high resolution image sensors.

With the advancement of technology of digital processing technologies, compact digital cameras are becoming capable of advanced programmable features, although such capabilities are not necessarily required for operation of compact cameras. Also, with the advancement of image sensor technologies, a large size and high resolution image sensor may be deployed in the compact digital camera without a great additional incremental cost.

In many situations, a compact digital camera and a complex digital camera are owned by one person or a family. For example, family members may use the compact digital camera at birthday parties, family outings, and other recreational events where the convenience of capturing reasonably decent images is very desirable. At other times, the same family member or a different family member may use the complex digital camera to capture a special image, such as a portrait, wildlife, a panoramic scenic view or other image where precise control of image capture operation is desirable.

Having two separate digital cameras may be inconvenient and expensive. There are two separate initial purchase costs. Accessories for the complex digital camera and the compact digital camera may be duplicative. For example, separate camera carrying cases may be required. Also, different image processing software may be required when the user is processing digital images on their processing system, such as a personal computer. Furthermore, accessories such as batteries and memory units may be incompatible between the two cameras.

### SUMMARY

The present invention provides a system and method for capturing images.

Briefly described, one embodiment comprises a digital camera, the digital camera comprising at least a photosensor; and an enclosure configured to receive the digital camera, configured to have at least one feature controlling operation of the digital camera, and configured to capture an image using the photosensor of the digital camera.

Another embodiment comprises coupling a digital camera and a camera enclosure, the digital camera residing within a recess of the enclosure, selecting at least one image capture feature using a device residing on the enclosure, and capturing an image on a photosensor residing in the digital camera, the image captured through a lens residing on the camera enclosure

### BRIEF DESCRIPTION OF THE DRAWINGS

The components in the drawings are not necessarily to scale relative to each other. Like reference numerals designate corresponding parts throughout the several views.

FIG. 1A is a front-side view in perspective of an embodiment of a digital camera in accordance with the present invention.

FIG. 1B is a back-side view of an embodiment of a digital camera in accordance with the present invention.

FIG. 1C is a bottom-side view of an embodiment of a digital camera in accordance with the present invention.

FIG. 2 is a front-side view in perspective of an embodiment of a camera enclosure in accordance with the present invention.

FIG. 3 is a back-side view of an embodiment of a camera enclosure in accordance with the present invention.

FIG. 4 is a back-side view of another embodiment of a camera enclosure in accordance with the present invention.

FIG. 5 is a block diagram illustrating components of embodiments of the digital camera and embodiments of the camera enclosure.

FIG. 6 is a flowchart illustrating a process for capturing an image when the digital camera is coupled to the camera enclosure.

### DETAILED DESCRIPTION

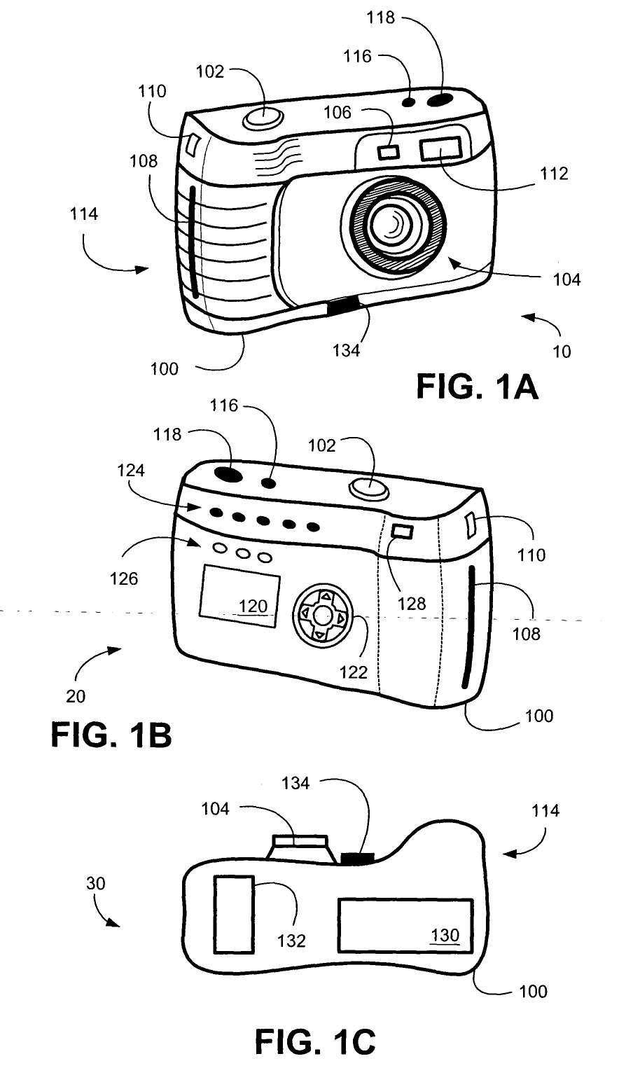

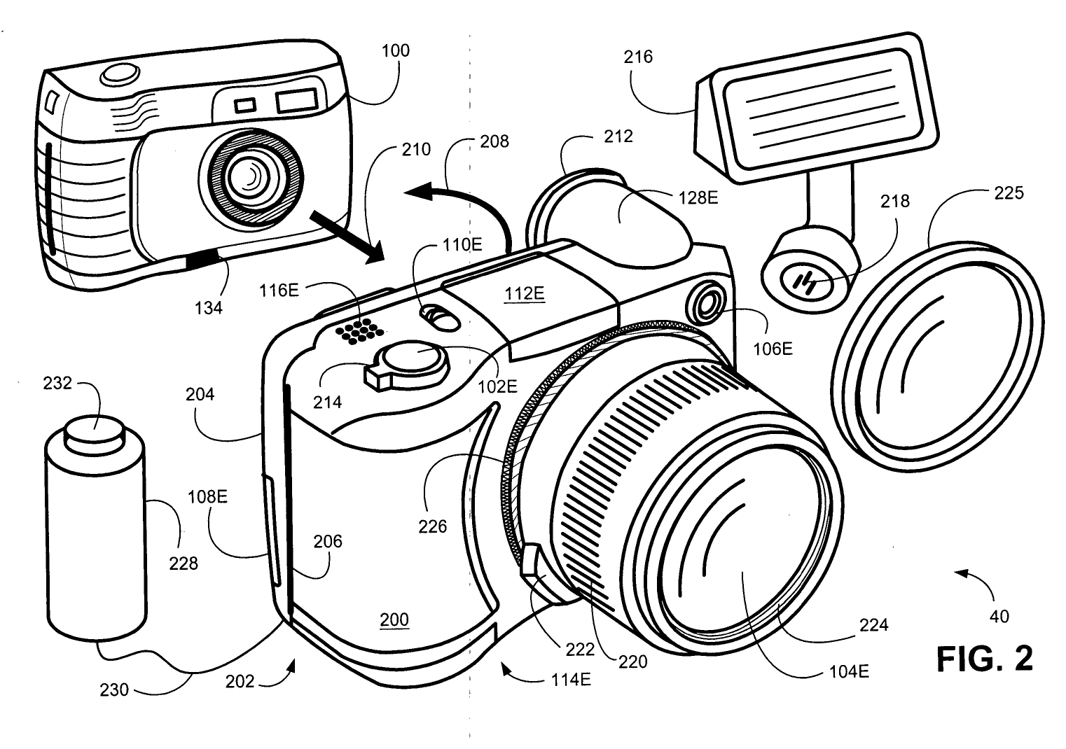

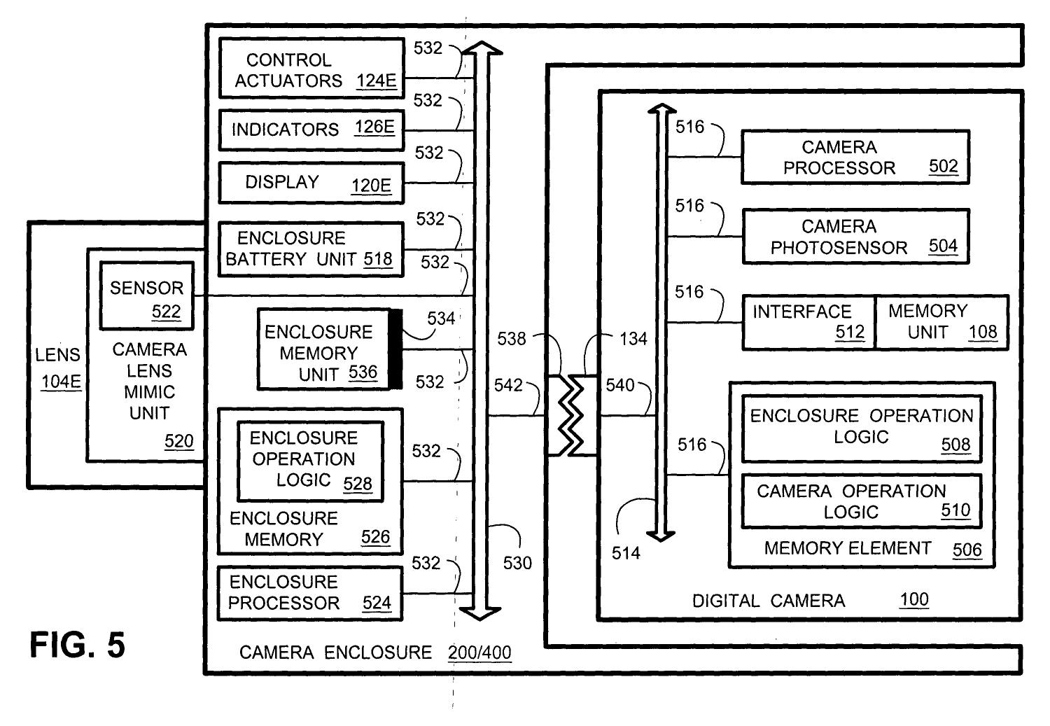

The present invention, an image capture system, provides a system and method for coupling a digital camera 100 (FIGS. 1A-1C) with a camera enclosure 200 (FIG. 2). The camera enclosure 200 provides at least some of the functionality of a complex digital camera. Also, camera enclosure 200 may be configured to mimic features and/or functions of more sophisticated film or digital cameras. Digital camera 100 is configured to be communicatively coupled with and physically coupled to the camera enclosure 200. Digital camera 100 is configured to provide the functionality and convenience of a compact digital camera. Accordingly, the functionality of both the compact digital camera and more sophisticated film or digital cameras are provided using a single image sensor, such as camera photosensor 504 (FIG. 5) or the like, residing in the digital camera 100. Furthermore, in one embodiment, a single processing system is used to control the operation of both the digital camera 100 and the camera enclosure 200.

For convenience, an “image” is defined herein to include any of the various forms of digital information corresponding to an image that is captured by a digital camera. As used herein, the term “compact digital camera” includes smaller, less complex digital cameras typically found in the market that provide simplified “point-and-shoot” capability in a small sized, relatively inexpensive image capture device. “Point-and-shoot” capability refers to an operating mode wherein the user simply aims the digital camera at the object of interest, and the digital camera automatically determines appropriate image capture parameters, such as focus, as part of the image capture process. The term “complex digital camera” includes complex digital image capture devices that provide a plurality of control features used by a professional or advanced photographer who desire the capability to specify a plurality of image capture and/or camera operating functions. For example, the user may specify the image focus parameter through a suitable interface before causing the complex digital camera to capture the image.

FIG. 1A is a front-side view 10 in perspective of an embodiment of a digital camera 100 in accordance with the present invention. Generally, the digital camera 100 mimics the compact cameras available on the market which are convenient to operate. Thus, the digital camera 100 is generally smaller in size and relatively automatic. One embodiment of digital camera 100 provides a fully automated point-and-shoot operating mode where the user simply aims the digital camera at an object of interest and actuates shutter button 102 to cause the digital camera 100 to capture an image of the object.

The exemplary embodiment of digital camera 100 includes shutter button 102, lens 104, view finder 106, optional memory unit 108, on/off switch 110, flash 112, ergonomic grip 114, a microphone 116 and a speaker 118. Similar features are found on conventional compact digital cameras.

FIG. 1B is a back-side view 20 in perspective of an embodiment of a digital camera 100 in accordance with the present invention. Additionally illustrated on the back-side of digital camera 100 is a display 120, a multifunction controller 122, a plurality of controllers 124 (such as buttons, switches or touch sensors), a plurality of indicators 126 (such as light generating devices), and the viewing port 128 (for viewing through view finder 112).

FIG. 1C is a bottom-side view 30 of an embodiment of a digital camera 100 in accordance with the present invention. Additionally illustrated on the bottom-side view of digital camera 100 is a battery cover 130 covering a receptacle wherein a battery (not shown) configured to power the digital camera resides. Also illustrated is another cover 132 that protects other suitable components, such as, but not limited to, a memory unit, access ports configured to receive connectors to other devices, a uniform serial bus (USB) connector, and/or a coupler to a power supply recharging device.

It is understood that the above-described embodiment of digital camera 100 is intended an exemplary embodiment. The digital camera 100, in other embodiments, may be of any shape or configuration, may include more or less features, and may be smaller or larger, than the illustrated embodiment of the digital camera 100. Accordingly, the digital camera 100 may be configured to appeal to selected purchasers. Furthermore, a plurality of digital cameras 100, each having different features or options, may be configured to couple to the same camera enclosure 200, thereby providing a variety of products to different consumers.

The illustrated embodiment of digital camera 100 further includes a coupler 134 configured to communicatively couple with a corresponding coupler 532 (FIG. 5) residing on camera enclosure 200 (FIGS. 2 and 5) and or camera enclosure 400 (FIGS. 4 and 5). Couplers 134 and 532 are described in greater detail below.

Embodiments of digital camera 100 include at least one limitation in its operation. The limitation is a result of the smaller size and/or operation convenience that inherently results from the compactness and/or operation simplicity of the digital camera 100. Accordingly, the camera enclosure 200 is configured to overcome the limitation when the digital camera 100 is coupled to the camera enclosure 200 in accordance with the present invention. Thus, camera enclosure enhances at least one function of digital camera 100.

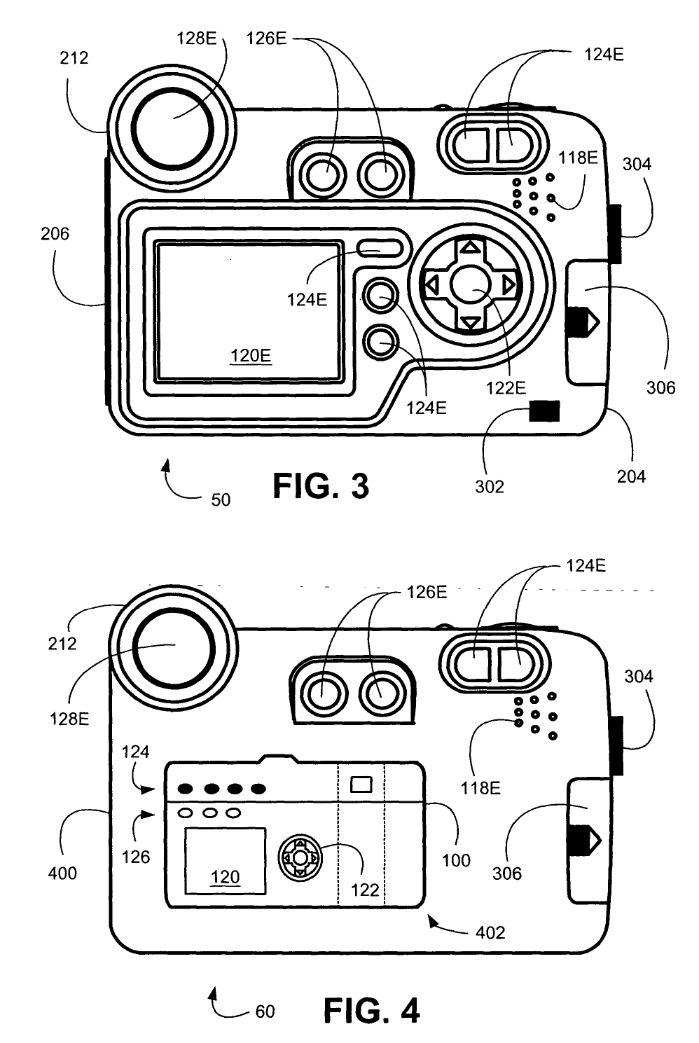

One illustrative example of a limitation is battery capacity. A relatively small battery or other suitable power source is provided in one embodiment of digital camera 100 (FIGS. 1A-1C). A supplemental power supply, such as a larger battery (not shown) or the like, or a suitable coupler 302 (FIG. 3) to an auxiliary power source, is provided by camera enclosure 200 to power both the digital camera and the camera enclosure. Accordingly, the smaller battery in digital camera 100 provides for a reasonable operation life for convenience, and the power provided from a power source coupled to the camera enclosure 200 provides for extended periods of operation. Other exemplary limitations of the various embodiments of digital camera 100, which are resolved by camera enclosure 200, are described below.

FIG. 2 is a front-side view 40 in perspective of an embodiment of a camera enclosure 200 in accordance with the present invention. Also illustrated in FIG. 2 is the digital camera 100, and a plurality of exemplary auxiliary components configured to attach to camera enclosure 200. FIG. 3 is a back-side view 50 of an embodiment of a camera enclosure 200 having an exemplary back portion 204 in accordance with the present invention.

Embodiments of digital camera 100 are configured to communicatively couple and physically couple with embodiments of camera enclosure 200. When the digital camera 100 is communicatively coupled and physically coupled with camera enclosure 200, the camera photosensor 504 (FIG. 5) of the digital camera 100 is used to capture images using features provided by the camera enclosure 200, as described in greater detail below. Thus, a single camera photosensor 504 is used to capture images with digital camera 100, and to capture images when the digital camera 100 is coupled to the camera enclosure 200.

In another embodiment, the camera processor 502 residing in digital camera 100 (FIG. 5) may be used for operation of the electronic controllable features of camera enclosure 200. In yet another embodiment, the camera processor 502 operates in conjunction with an enclosure processor 524 (FIG. 5) residing in the camera enclosure 200 (FIGS. 2 and 5) or in camera enclosure 400 (FIGS. 4 and 5).

The embodiment of camera enclosure 200 includes a front portion 202 and a back portion 204. Hinge 206 connects the front portion 202 to the back portion 204 such that the front portion 202 and the back portion 204 may be conveniently separated, as indicated by direction arrow 208, so that the digital camera 100 may be communicatively coupled and physically coupled to the camera enclosure 200, as indicated by the direction arrow 210. In the exemplary embodiment of digital camera 100 and camera enclosure 200 of FIG. 2, digital camera 100 is configured to fit within the camera enclosure 200. Back portion 204 is returned to its original position, thereby entirely enclosing the digital camera 100 within camera enclosure 200.

For convenience, the hinge 206 is illustrated on the side of the camera enclosure 200. In other embodiments, the hinge 206 is located in another convenient location on camera enclosure 200. In another embodiment, other connection means are employed to physically couple the back portion 204 to the front portion 202. The means may provide a hinge-like functionality. Or, the back portion 204 may be physically separated from the front portion 202, and then returned to its original position and held in place with suitable fastening means, such as clips, snaps, tabs or the like after the digital camera 100 is placed inside the camera enclosure 200.

In accordance with the present invention, digital camera 100 includes at least one limitation that is resolved by the camera enclosure 200 when the digital camera 100 is physically and communicatively coupled to camera enclosure 200. Other exemplary limitations are described below.

In one embodiment, digital camera 100 includes a relatively small view finder 106 (FIG. 1A) and a relatively small viewing port 128 (FIG. 1B) for viewing through view finder 106. For some users, the relatively small view finder 106 and/or the relatively small viewing port 128 may be difficult to see through. In one embodiment, view finder 106 includes few, if any, viewing features such as internal displays configured to display sensed distance, sensed light conditions, device setting indicators, frame boundary indicators, or the like, which are not necessarily required by the automatic point-and-shoot functionality of the digital camera 100. However, some users may desire such features when capturing images. Accordingly, in one embodiment, camera enclosure 200 includes a view finder 106E and/or viewing port 128E (FIG. 2) that are easier and/or are more accurate for a user to view through. View finder 106E may include magnification features, sensed distance, sensed light conditions, device setting indicators, frame boundary indicators, or the like. Viewing port 128E may include a flexible plastic or rubber attachment 212 that is comfortable and/or shades the user's eye for better viewing. In one embodiment, view finder 106E and/or viewing port 128E are separate devices from the view finder 106 and/or viewing port 128. In another embodiment, view finder 106E, viewing port 128E, view finder 106, and viewing port 128 are serially oriented so that the user views the object through the components. The view finder 106E and/or viewing port 128E, in one embodiment, are configured to mimic view finders and/or viewing ports found on more sophisticated film or digital cameras.

In one embodiment, digital camera 100 includes a relatively small on/off switch 110 (FIGS. 1A-1B). For some users, the relatively small on/off switch 110 may be difficult to actuate. Accordingly, some users may desire a larger on/off switch 110E (FIG. 2). Accordingly, in one embodiment, camera enclosure 200 includes on/off switch 110E that is easier for a user to actuate. The on/off switch 110E, in one embodiment, is configured to mimic on/off switches found on more sophisticated film or digital cameras.

In one embodiment, digital camera 100 includes a relatively small shutter button 102 (FIGS. 1A-1B). For some users, the relatively small shutter button 102 may be difficult to actuate and/or may not have the tactile characteristics or “feel” of a more sophisticated film or digital camera. In one embodiment, the shutter button 102 may include few, if any, supplemental controllers which are not necessarily required by the automatic point-and-shoot functionality of the digital camera 100. However, some users may desire a larger shutter button 102E (FIG. 2) having additional control features when capturing images. Accordingly, in one embodiment, camera enclosure 200 includes a larger shutter button 102E that is easier for a user to actuate and/or has a tactile characteristic that provide relatively more precise shutter control. Shutter button 102E may include a supplemental controller, such as switch 214, configured to perform a supplemental function. The shutter button 102E, in one embodiment, is configured to mimic shutter buttons found on more sophisticated film or digital cameras.

In one embodiment, digital camera 100 includes a relatively small flash 112 (FIG. 1A) that may not be sufficient to light relatively larger areas and/or areas relatively farther away from the digital camera 100. Accordingly, some users may desire a larger flash 112E (FIG. 2) provides a greater amount of light. For convenience, the flash 112E is illustrated as a “pop-up” flash that, when in use, rises up from the top of the camera enclosure. When not in use, the flash 112E retracts. In another embodiment, the camera enclosure 200 includes a supplemental coupler 304 (FIG. 3), such as a “hot shoe” or the like, configured to couple the camera enclosure 200 to a flash attachment 216 (FIG. 2), via a coupler 218 on the flash attachment 216. Flash attachment 216 is a strobe device providing, a brief period of bright light generated during the time of image capture. The coupler 218, in one embodiment, is configured to mimic flash attachment couplers found on more sophisticated film or digital cameras.

In other embodiments, a remote strobe or flash device is actuated by the camera enclosure via a wireless medium. One illustrative example is the “slave flush” which causes image capture in response to or synchronized with camera strobe flushes. Other examples of suitable wireless mediums include, but are not limited to, radio frequency (RF), infrared, laser, microwave, ultrasonic sound or other suitable wireless communication media.

In one embodiment, digital camera 100 includes a relatively small ergonomic grip 114 (FIGS. 1A-1C). For some users, the relatively small ergonomic grip 114 may be difficult to hold, thereby resulting in an unclear image caused by movement, shaking or jitter. Accordingly, some users may desire an ergonomic grip 114E (FIG. 2) that is easier to hold, thereby providing greater stability when capturing images. Accordingly, in one embodiment, camera enclosure 200 includes a larger ergonomic grip 114E. In another embodiment, a tripod mounting attachment (not shown) is provided on the underside, or in another suitable location, of the camera enclosure 200. The ergonomic grip 114E, in one embodiment, is configured to mimic ergonomic grips found on more sophisticated film or digital cameras.

In one embodiment, digital camera 100 includes a relatively small microphone 116 and/or a relatively small speaker 118 (FIGS. 1A-1B). For some users, the relatively small microphone 116 and/or speaker 118 may be of relatively low audio fidelity and therefore more difficult to hear. Microphone 116 may not be sensitive to detect some sounds and/or may not have desired directional characteristics. Accordingly, some users may desire a larger microphone 116E (FIG. 2) and a larger speaker 118E (FIG. 3) when capturing sound associated with captured images. Accordingly, in one embodiment, camera enclosure 200 includes a microphone 116E and/or a larger speaker 118E.

In one embodiment, digital camera 100 includes a relatively small display 120 (FIG. 1B). For some users, the relatively small display 120 may be difficult to see. Some users may desire a larger display 120E (FIG. 3) that is easier to see and that is large enough to display larger, more complex operating menus. In one embodiment, the display 120 may display higher resolution images and/or larger, more complex operating menus (which are not necessarily required by the automatic point-and-shoot functionality of the digital camera 100). Accordingly, in one embodiment, camera enclosure 200 includes a larger display 120E that is easier for a user to view.

In one embodiment, digital camera 100 includes a relatively small multifunction controller 122 (FIG. 1B). For some users, the relatively small multifunction controller 122 may be difficult to actuate. In one embodiment, the multifunction controller 122 may include fewer features because of the automatic point-and-shoot functionality of the digital camera 100. Accordingly, some users may desire a larger shutter multifunction controller 122E (FIG. 3) having additional control features when capturing images. In one embodiment, camera enclosure 200 includes a larger multifunction controller 122E that is easier for a user to actuate. Multifunction controller 122E may include supplemental controllers configured to perform supplemental functions. The multifunction controller 122E, in one embodiment, is configured to mimic shutter buttons found on more sophisticated film or digital cameras.

In one embodiment, digital camera 100 includes a relatively few number of controllers 124 (FIG. 1B) (such as buttons, switches or touch sensors) and/or a relatively few number of indicators 126 (FIG. 1B) (such as light generating devices, meters and the like), which are not necessarily required by the automatic point-and-shoot functionality of the digital camera 100. For some users, the relatively few number of controllers 124 and/or a relatively few number of indicators 126 may be insufficient to provide a high degree of control during image capture. Accordingly, some users may desire a larger number of controllers 124E and/or indicators 126E (FIG. 3) when capturing images. Also the controllers 124 and/or indicators 126 may be small, and thereby relatively difficult to actuate and/or view. Accordingly, in one embodiment, camera enclosure 200 includes larger controllers 124E and/or indicators 126E that are easier for a user to actuate and view. The controllers 124E and/or indicators 126E, in one embodiment, are configured to mimic controllers and/or indicators found on more sophisticated film or digital cameras.

In one embodiment, digital camera 100 includes a relatively small capacity memory unit 108 (FIGS. 1A-1B). For some users, the relatively small capacity memory unit 108 may have sufficient capacity for image capture at events such as at parties, social functions, short trips or the like. However, some users may desire a larger capacity memory unit 108E (FIG. 5) when a large number of images are to be captured and/or when higher resolution images are saved into memory. Accordingly, in one embodiment, camera enclosure 200 includes a larger capacity memory unit 108E. The memory unit 108E is internal in one embodiment, and is removable in another embodiment. In another embodiment, a plurality of removable memory units may be provided. Memory unit(s) 108E may be standardized units that are interchangeable with each other and/or interchangeable with other devices. Furthermore, a plurality of separate memory units may be desirable from a perspective of managing images. For example, the memory unit of a digital camera may be understood by one or more users, such as family members, to be used for images captured in the memory unit of the digital camera 100 that is available for all users. On the other hand, at least one of the memory units of camera enclosure unit 200 may be understood to be used only for one particular user's individual use, such as when a series of professional photographs are taken with the camera enclosure 200. In one embodiment, the memory unit(s) 108E is accessible through, and protected by, cover 306 (FIG. 3).

In one embodiment, digital camera 100 includes a relatively small lens 104 (FIG. 1A). For some users, the relatively small lens 104 may not be sufficient to capture certain images. In one embodiment, the lens 104 may include few, if any, supplemental controllers which are not necessarily required by the automatic point-and-shoot functionality of the digital camera 100. However, some users may desire a larger lens 104E (FIG. 2) having advanced optical properties such as, but not limited to, zoom range, shutter speed (f-number), etc., or having additional control features when capturing images. Accordingly, in one embodiment, camera enclosure 200 includes a larger lens 104E. Lens 104E may include a supplemental controller, such as one or more control rings 220 (FIG. 2), configured to perform a supplemental function. The lens 104E, in one embodiment, is configured to mimic lens found on more sophisticated film or digital cameras.

Any suitable lens 104 may be employed on embodiments of camera enclosure 200. The lens may have a fixed or variable focus length, angle of range (such as a typical angle or a wide angle), or other suitable lens features.

One lens embodiment includes a focus control device, such as control ring 220 (FIG. 2), that is configured to mimic lens focus rings found on more sophisticated film or digital camera lens. Another embodiment includes an aperture setting means, such as an aperture ring 222, that is configured to mimic lens focus rings found on more sophisticated film or digital camera lens. The focus means and aperture means are communicatively coupled to one or more suitable sensors 522 (FIG. 5) that provides signals to enclosure processor 524 and/or camera processor 502, depending upon the embodiment, such that the intentions of the user can be determined to set image capture parameters to desired values.

Another embodiment includes an attachments device, such as threads 224 or other suitable fasteners, configured to receive an auxiliary lens cover 225 (FIG. 2). The attachment means may be further configured to receive specialty lens, such as colored lens, filter lens or the like. Such an attachment means may be configured to mimic lens attachment means found on more sophisticated film or digital cameras.

Another embodiment of camera enclosure 200 does not include lens 104E (FIG. 2). This embodiment includes a lens coupler 226 that is configured to receive a lens unit and physically secure the lens to the camera enclosure. Accordingly, the user may have a plurality of specialty lens that are configured to couple to the camera enclosure 200. Lens coupler, in one embodiment, is configured to mimic lens attachment devices found on more sophisticated film or digital cameras.

In some embodiments of lens 104E, a control ring 220 (FIG. 2) or other suitable controller provides a zoom feature. Thus, the zoom control ring 220 adjusts the focal length of the lens 104E. Rotating the control ring 220 increases/decreases magnification of the object of interest. In some embodiments, the zoom function control ring 220 is configured to mimic zoom devices found on a more sophisticated film or digital camera lens.

In one embodiment, camera enclosure 200 (FIG. 2) includes a means to receive image capture instructions from an auxiliary unit. For example, but not limited to, a remote shutter device 228 is illustrated as coupled to camera enclosure 200, via connection 230. Accordingly, when the user actuates button 232, an image is captured. Other types of remote shutter devices may be configured to communicate to camera enclosure 200. For example, but not limited to, the remote shutter device 228 and the camera enclosure 200 may be configured to communicate via radio frequency (RF), infrared, laser, microwave, ultrasonic sound or other suitable wireless communication media. In one embodiment, the remote shutter device 228 includes supplemental controllers configured to perform supplemental functions. The remote shutter device 228, in one embodiment, is configured to mimic remote shutter devices used by more sophisticated film or digital cameras.

FIG. 4 is a back-side view of another embodiment of a camera enclosure 400 in accordance with the present invention. Camera enclosure 400 comprises a single portion having a receptacle 402 in which digital camera 100 is inserted. Accordingly, the controllers 122 and 124, indicators 126 and display screen 120 of the digital camera 100 are used during operation when the camera enclosure 400 is employed. Camera enclosure 400 includes other suitable features, as described above.

Other embodiments of digital camera 100 are configured to couple to a plurality of camera enclosures 200 and/or 400. Such camera enclosures, which include some or all of the above described features, are configured with a particular use in mind. For example, a camera enclosure may be configured for use at night or under low ambient light conditions. In such an embodiment, controllers, indicators and other features may be illuminated for better viewing in low ambient or no ambient light conditions. Furthermore, image capture parameters may be preset. For example, a range of lower (slower) exposure settings may be provided. Features of the camera enclosure may be modified differently from the above-described features of camera enclosures 200 and/or 400. For example, a larger flash unit, or a flash unit generating different light frequencies, may be provided. Or, a built-in tripod or other stabilizing device may be built-in to provide greater stability for the longer exposure time required to capture images in low ambient light conditions.

Another embodiment is a camera enclosure configured for action, sports and/or outdoor photography. The camera enclosure embodiment is configured to be more rugged. That is, the camera enclosure may be designed and composed of materials to withstand physical abuse, such as dropping, fast movements, water resistance, extreme temperatures, or other perils that the camera enclosure may encounter during action, sports, outdoor or underwater use. Or, the camera enclosure may be configured for a user wearing specialty apparel, such as gloves or protective eye covers. Furthermore, image capture parameters may be preset. For example, a range of higher (faster) exposure settings may be provided for action shots wherein the subject of the captured image is quickly moving. One embodiment employs a security strap system which secures the camera enclosure to the user or another object.

Another embodiment is a camera enclosure configured for portrait photography. The camera enclosure embodiment includes a larger, higher resolution display so that preview images can be viewed. Furthermore, image capture parameters may be preset. For example, a range of soft focus features or other image capture features may be provided for portrait shots. One embodiment of the camera enclosure is configured such that a plurality of flash units may be controlled.

Another embodiment is a camera enclosure configured for landscape and/or scenic photography. The camera enclosure embodiment includes a variety of means for coupling the camera enclosure to different types of position fixing devices, such as tripods or the like. Furthermore, image capture parameters may be preset. For example, a range of image capture angle features, such as a panoramic view or the like, or other image capture features may be provided for landscape and/or scenic shots.

FIG. 5 is a block diagram illustrating components of embodiments of the digital camera and embodiments of the camera enclosure. Digital camera 100 includes camera processor 502, camera photosensor 504 and memory element 506. Memory element 506 includes regions for the enclosure operation logic 508 and the camera operation logic 510. For convenience, enclosure operation logic 508 and the camera operation logic 510 are described as separate logic. However, in alternative embodiments, the enclosure operation logic 508 and the camera operation logic 510 are integrated into a single logic.

Embodiments of digital camera 100 include an interface 512 wherein the memory unit 108 couples to. Any suitable formatted detachable memory unit configured to store at least data corresponding to captured images may be used. In other embodiments, detachable memory units are not employed. Rather, captured images are stored in memory element 506 or in another memory medium.

Camera processor 502, camera photosensor 504, memory element 506 and interface 512, and other components not shown, are coupled to communication bus 514 via connections 516, thereby providing connectivity between the above-described components. In alternative embodiments of digital camera 100, the above-described components are connectivley coupled to each other in a different manner than illustrated in FIG. 5. For example, one or more of the above-described components may be directly coupled to camera processor 502, or may be coupled to camera processor 502 via intermediary components (not shown).

Camera enclosure 200 and camera enclosure 400 (referred hereinafter as camera enclosure 200/400 for convenience) includes a variety of features as described herein. For example, camera enclosure 200/400 embodiment may include control actuators 124E, indicators 126E, display 120E and/or lens 104E. Another embodiment includes the enclosure battery unit 518, thereby providing an additional power source.

One embodiment of lens 104E includes the camera lens mimic unit 520. This device mimics the devices and/or controllers employed by more sophisticated film or digital camera lens, such as aperture, focus and zoom controllers. One or more sensors 522 are included that detect the settings of the camera lens mimic unit 520. Sensors 522 generate information signals corresponding to the detected settings.

One embodiment of camera enclosure 200/400 includes enclosure processor 524 and/or enclosure memory 526. Enclosure memory 526 includes enclosure operation logic 528. Another embodiment does not employ either enclosure processor 524 or enclosure memory 526. Yet another embodiment employs enclosure processor 524, but does not employ enclosure memory 526. These embodiments are described in greater detail below.

In the embodiment of camera enclosure 200/400 illustrated in FIG. 5, the above-described components are coupled to communication bus 530 via connections 532, thereby providing connectivity between the above-described components. In alternative embodiments of camera enclosure 200/400, the above-described components are connectivley coupled to each other in a different manner than illustrated in FIG. 5. For example, one or more of the above-described components may be directly coupled to enclosure processor 524, or may be coupled to enclosure processor 524 via intermediary components (not shown).

Similar to the digital camera 100, camera enclosure 200/400 includes an interface 534 wherein an enclosure memory unit 536 couples to. Any suitable formatted enclosure memory unit 536 configured to store at least data corresponding to captured images may be used. In other embodiments, enclosure memory unit 536 is not employed. Rather, captured images are stored in another memory medium.

Digital camera 100 includes a coupler 134 configured to communicatively couple with a corresponding coupler 538 residing on camera enclosure 200/400. Couplers 134 and 538 are configured to communicatively and physically mate together when the digital camera 100 is coupled to camera enclosure 200/400. Coupler 134 is connected to bus 514 via connection 540. Coupler 538 is connected to bus 530 via connection 542.

Enclosure processor 524, in one embodiment, is configured to receive and provide signals to the above-described components of the camera enclosure 200/400. In this embodiment, enclosure operation logic 528 is retrieved and executed by the enclosure processor 524, and camera processor 502 and enclosure processor 524 communicate with each other as required for capturing images when the digital camera 100 is coupled to the camera enclosure 200/400. For example, a signal may be communicated from one of the control actuators 124E to enclosure processor 524, via bus 530. Enclosure processor 524 then formats a corresponding signal and communicates the signal to camera processor 502 (via bus 530, coupler 538, coupler 134 and bus 514), whereby operation of image capture by the camera photosensor 504 is controlled in accordance with the signal generated by the control actuator 124E.

In response to the above simplified example, camera processor 502 may determine an indication that is to be indicated by one of the indicators 126E residing on the camera enclosure 200/400. Accordingly, a signal is generated by camera processor 502, communicated to enclosure processor 524 (along a reverse path via bus 514, coupler 134, coupler 538 and bus 530). Enclosure processor interprets the received signal, and then generates and communicates a suitable signal to the indicator 126E.

In another embodiment of the digital camera 100 and the camera enclosure 200/400, enclosure processor unit 524 and enclosure memory 526 are not employed. Rather, camera processor 502, as a result of retrieving and executing enclosure operation logic 508, directly communicates with the various components of camera enclosure 200/400.

Yet another embodiment employs enclosure processor 524, but does not employ enclosure memory 526. All necessary logic for operation of the enclosure 200/400 resides in the enclosure operation logic 508.

In the above-described embodiments, the couplers 134 and 538 are configured to communicate signals that are formatted in a suitable digital, bus architecture format so that a plurality of different signals are communicated over busses 514 and 530. Couplers 134 and 538 may be specially configured couplers, or may be based on other technologies, such as, but not limited to an RS-232 format or a universal serial bus (USB format). Furthermore, the physical construction of the couplers 134 and 538 may be specially configured, or may be based on other technologies, such as a USB cable.

In another embodiment, a “wire-per-function” format is employed. Accordingly, bus 530, enclosure processor 524 and enclosure memory 526 are not employed in the camera enclosure 200/400. In this embodiment, each of the above-described components are coupled to coupler 538 with one or more physical connections. Couplers 134 and 538 employ a plurality of pins and corresponding receptacles so that when couplers 134 and 538 are physically mated to each other, the above-described components are directly coupled to and are in communication with digital camera 100.

Various embodiments of camera enclosures 200 (FIG. 2) and/or 400 (FIG. 4) are described as having features that mimic devices found on more sophisticated film or digital cameras. Accordingly, such devices may be located in locations that are familiar to users of more sophisticated film or digital cameras. Furthermore, the operation of such devices are configured to look and feel like devices that are familiar to users of more sophisticated film or digital cameras. Similarly, indicators such as markings, settings, values may mimic corresponding devices on more sophisticated film or digital cameras. Thus, embodiments of camera enclosures that mimic features of more sophisticated film or digital cameras may be very desirable by some consumers.

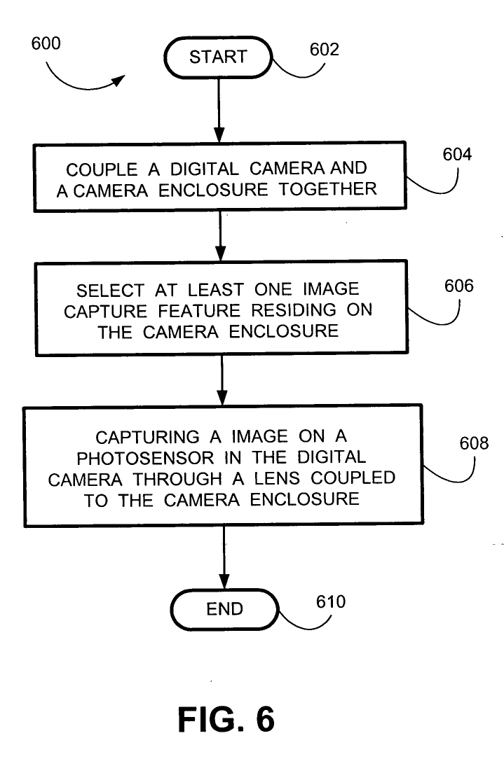

FIG. 6 is a flowchart illustrating a process for capturing an image when the digital camera 100 (FIGS. 1A-1C) is coupled to the camera enclosure 200 or 400 (FIGS. 2 and 4). The flow chart 600 shows the architecture, functionality, and operation of a possible implementation of the software for implementing the enclosure operating logic 506 and/or 528 (FIG. 5). In this regard, each block may represent a module, segment, or portion of code, which comprises one or more executable instructions for implementing the specified logical function(s). It should also be noted that in some alternative implementations, the functions noted in the blocks may occur out of the order noted in FIG. 6 or may include additional functions without departing significantly from the functionality of the present invention. For example, two blocks shown in succession in FIG. 6 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure for digital camera 100 and the camera enclosure 200/400.

The process begins at block 602. At block 604 the digital camera 100 and the camera enclosure 200/400 are coupled together. At block 606 at least one of the above described features of the camera enclosure 200/400 are selected. For example, shutter 102E (FIG. 2) could be selected to cause image capture. Or, on/off switch 110E (FIG. 2) could be selected to activate the digital camera 100 and the camera enclosure 200/400. Or, view finder 106E (FIG. 2) could be selected for viewing objects. At block 608, an image is captured on photosensor 504 (FIG. 5) residing in the digital camera 100, wherein the image is captured through at least the lens 104E (FIG. 2) coupled to the camera enclosure 200/400. The process ends at block 610.

It should be emphasized that the above-described embodiments are merely examples of implementations. Many variations and modifications may be made to the above-described embodiments. All such modifications and variations are intended to be included herein within the scope of this disclosure and protected by the following claims.

1. An image capture system comprising:
a digital camera, the digital camera comprising at least a photosensor; and
an enclosure configured to receive the digital camera, configured to have at least one feature controlling operation of the digital camera, and configured to capture an image using the photosensor of the digital camera.

2. The image capture system of claim 1, further comprising a processor configured to control operation of the digital camera and the enclosure.

3. The image capture system of claim 1, further comprising:
a first processor residing in the digital camera and configured to control operation of the digital camera and the enclosure; and
a second processor residing in the enclosure, configured to control at least partial operation of the enclosure.

4. The image capture system of claim 3, wherein the second processor controls operation of the enclosure.

5. The image capture system of claim 3, wherein the first processor and the second processor operate in conjunction to control operation of the enclosure.

6. The image capture system of claim 1, wherein the enclosure further comprises:
a first portion; and
a second portion,
wherein the digital camera is configured to be enclosed within the first portion and the second portion.

7. The image capture system of claim 1, wherein the enclosure further comprises a receptacle configured to receive the digital camera.

8. The image capture system of claim 1, wherein the enclosure further comprises a coupler configured to receive a flash attachment, and wherein the digital camera is configured to cause the flash attachment to flash.

9. The image capture system of claim 1, wherein the digital camera further comprises a first ergonomic grip and the enclosure further comprises a second ergonomic grip, the second ergonomic grip larger than the first ergonomic grip.

10. The image capture system of claim 1, wherein the digital camera further comprises a first display and the enclosure further comprises a second display, the second display larger than the first display.

11. The image capture system of claim 1, wherein the digital camera further comprises at least one first controller configured to control an operation of image capturing and the enclosure further comprises at least one second controller configured to control the operation of image capturing, the second controller having at least one feature different from the first controller.

12. The image capture system of claim 11, wherein the enclosure further comprises a third controller configured to control a different operation of image capturing that is not controllable by the digital camera.

13. The image system of claim 1, wherein the enclosure further comprises at least one indicator configured to indicate an operation of image capturing not indicated by the digital camera.

14. The image capture system of claim 1, wherein the digital camera further comprises a first lens and the enclosure further comprises a second lens, the second lens having at least one feature different from the first lens.

15. The image capture system of claim 14, wherein the enclosure further comprises a lens coupler configured to couple the second lens to the enclosure, and where the lens coupler permits the second lens to detach from the enclosure.

16. The image capture system of claim 14, wherein the enclosure further comprises a focus ring residing on the enclosure and configured to adjust a focus of the image.

17. The image capture system of claim 14, wherein the enclosure further comprises an aperture ring residing on the enclosure and configured to adjust an aperture used when capturing the image.

18. The image capture system of claim 14, wherein the enclosure further comprises a zoom control ring residing on the enclosure and configured to adjust a focal length of the second lens used when capturing the image.

19. A method for capturing images, the method comprising the steps of:
coupling a digital camera and an enclosure, the digital camera residing within a recess of the enclosure;
selecting at least one image capture feature using a device residing on the enclosure; and
capturing an image on a photosensor residing in the digital camera, the image captured through a lens residing on the camera enclosure.

20. The method of claim 19, further comprising the step of capturing the image with the digital camera when the digital camera is decoupled from the camera enclosure.

21. A method for capturing images, the method comprising the steps of:
generating an image capture instruction using a device residing on an enclosure;
communicating the image capture instruction to a digital camera coupled to the enclosure and residing within a recess of the enclosure; and
capturing an image with a photosensor residing in the digital camera, the step of capturing performed in accordance with the received image capture instruction.

22. An image capture system, comprising:
means for capturing an image with a photosensor residing in a digital camera;
means for coupling the digital camera to an enclosure; and
means for controlling a process of image capture with at least one device residing on the enclosure.

23. The image capture system of claim 22, further comprising a means for controlling operation of the digital camera and the enclosure.

24. The image capture system of claim 22, further comprising a second means for controlling operation of the enclosure, the second means for controlling operating in conjunction with the means for controlling operation of the digital camera and the enclosure.

25. The image capture system of claim 22, further comprising means for controlling at least one operation of an image capture process, the means for controlling residing in the enclosure and configured to control the digital camera.

26. The image capture system of claim 22, further comprising a means to couple a lens to the enclosure.

27. A computer-readable medium having a program for capturing images, the program comprising logic configured to perform the steps of:
receiving an image capture instruction from an enclosure; and
capturing an image with a photosensor residing in a digital camera when the digital camera is coupled to the enclosure, the step of capturing performed in accordance with the received image capture instruction.
